(19) United States
(12) Patent Application Publication
(10) Pub. No.: US 2007/0038312 A1
(43) Pub. Date: Feb. 15, 2007

(54) Parameter setting device, parameter setting method and program

(75) Inventors: Yoshihiro Fujita, Musashino-shi (JP); Chiaki Ito, Musashino-shi (JP); Makoto Murata, Musashino-shi (JP); Isao Uchida, Musashino-shi (JP); Tetsuya Ohtani, Musashino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Musashino-shi (JP)

(21) Appl. No.: 11/475,168

(22) Filed: Jun. 27, 2006

(30) Foreign Application Priority Data
Jun. 30, 2005 (JP) 2005-191631

(51) Int. Cl. G05B 15/00

(52) U.S. Cl. 700/1

(57) ABSTRACT

There are provided a parameter setting device capable of cutting down development costs, and various social costs by reducing the burden on work for optimizing parameter values, and so forth. An acquisition means acquires output results while varying parameter values of parameters. A determination means determines optimum parameter values on the basis of the output results acquired by the acquisition means. An acceptance means accepts a user's instruction for determining a procedure of acquiring the output results by the acquisition means, and a method of determining the optimum parameter values by the determination means. A storage means stores the output results acquired by the acquisition means. According to the parameter setting device of the invention, since the user's instruction for determining a procedure of acquiring the output results by the acquisition means, and a method of determining the optimum parameter values by the determination means is accepted, it is adaptable to various systems while reducing the burden on work for optimizing the parameter values.

### FIELD OF THE INVENTION

The invention relates to a parameter setting device for determining optimum parameter values on the basis of output results acquired while varying parameter values, and so forth, particularly to a parameter setting device having general versatility with respect to its various intended use, and so forth.

### BACKGROUND OF THE INVENTION

For example, in an electronic control unit for controlling an automobile engine, control is implemented by use of a multitude of control parameters. A development department, as work for optimizing the control parameters, finds out optimum values of the control parameters while repeating experiments, designated as “automatic calibration” for a long period of time.

Further, for example, in the case where fabrication processes of semiconductor devices are optimized, both a development department and a production department store correlation data between a multitude of parameters and states of occurrence of defective products, thereby finding out parameter values for maximizing a yield.

Still further, in the case of determination of a medical policy, an architectural design, and formulation of various planning, work for selecting optimum values of a multitude of variables is needed.

Disclosed in JP 2004-68729 A is an adapting method for an engine control parameter capable of efficiently acquiring a more accurately adaptable value for the control parameter by use of a model equation establishing a relationship between a characteristic value for an engine and the control parameter.

As mentioned above, fields requiring work for optimizing a multitude of parameter values are diversified. However, there has been generally a problem in that such work takes time and labor. Accordingly, appearance of approaches to reduce the burden on work for optimizing the parameter values has been intensively desired.

### SUMMARY OF THE INVENTION

It is an object of the invention to reduce the burden on work for optimizing parameter values, and to provide a parameter setting device capable of cutting off development costs, and various social costs, and so forth.

The parameter setting device according to the invention, for use in a system where output results undergo variation according to parameters, comprises an acquisition means for acquiring the output results while varying parameter values of the parameters, and a determination means for determining optimum parameter values on the basis of the output results acquired by the acquisition means, characterized in that the parameter setting device further comprises an acceptance means for accepting a user's instruction for determining a procedure of acquiring the output results by the acquisition means and a method of determining the optimum parameter values by the determination means.

The acceptance means may accept an input of a functional block diagrammatic form by the user, and the method of determination may be defined by the functional block diagrammatic form.

The parameter setting device further comprises a storage means for storing the output results acquired by the acquisition means, and the determination means may use the output results stored in the storage means.

The system may be a controlled object where the parameters are control parameters.

The system may be a model where the parameters are model parameters.

A parameter setting method according to the invention, for use in a system where output results undergo variation according to parameters, comprises a step of acquiring the output results by an acquisition means while varying parameter values of the parameters, and a step of determining optimum parameter values on the basis of the output results acquired by the acquisition means, characterized in that the parameter setting method further comprises a step of accepting a user's instruction for determining a procedure of acquiring the output results in the step of acquiring output results, and a method of determining the optimum parameter values in the step of determining optimum parameter values.

According to this parameter setting method, since the user's instruction for determining a procedure of acquiring the output results by the acquisition means, and a method of determining the optimum parameter values by the determination means is accepted, it is adaptable to various systems while reducing the burden on work for optimizing the parameter values.

In the step of accepting the user's instruction, an input of a functional block diagrammatic form by the user may be accepted and the method of determination may be defined by the functional block diagrammatic form.

The parameter setting method further comprising a step of storing the output results acquired in the step of acquisition, and the stored output results may be used in the step of determination.

The system may be a controlled object where the parameters are control parameters.

The system may be a model where the parameters are model parameters.

A program according to the invention, for use in a system where output results undergo variation according to parameters, comprises a step of causing a computer to execute acquisition of the output results while varying parameter values of the parameters, and a step of causing the computer to execute determination on optimum parameter values on the basis of the output results acquired by the acquisition means, characterized in that the computer is further caused to execute a step of accepting a user's instruction for determining a procedure of acquiring the output results in the step of causing the computer to execute the acquisition, and a method of determining the optimum parameter values in the step of causing the computer to execute the determination.

According to this program, since the user's instruction for determining a procedure of acquiring the output results by the acquisition means, and a method of determining the optimum parameter values by the determination means is accepted, it is adaptable to various systems while reducing the burden on work for optimizing the parameter values.

In the step of accepting the user's instruction, an input of a functional block diagrammatic form by the user may be accepted in the step of accepting the user's instruction, and the method of determination may be defined by the functional block diagrammatic form.

The program further allowing the computer to execute a step of storing the output results acquired in the step of acquisition, and the stored output results may be used in the step of determination.

The system may be a controlled object where the parameters are control parameters.

The system may be a model where the parameters are model parameters.

According to the parameter setting device of the invention, since the user's instruction for determining a procedure of acquiring the output results by the acquisition means, and a method of determining the optimum parameter values by the determination means is accepted, it is adaptable to various systems while reducing the burden on work for optimizing the parameter values.

According to the parameter setting method of the invention, since the user's instruction for determining a procedure of acquiring the output results by the acquisition means, and a method of determining the optimum parameter values by the determination means is accepted, it is adaptable to various systems while reducing the burden on work for optimizing the parameter values.

According to the program of the invention, since the user's instruction for determining a procedure of acquiring the output results by the acquisition means, and a method of determining the optimum parameter values by the determination means is accepted, it is adaptable to various systems while reducing the burden on work for optimizing the parameter values.

### BRIEF DESCRIPTION OF THE DRAWINGS

FIG. 1 is a block diagram functionally showing a parameter setting device of the invention;

FIG. 2 is a block diagram showing a configuration of a control system for controlling a controlled object by use of a multitude of control parameters;

FIG. 3 is a block diagram exemplifying a configuration of a control unit;

FIG. 4 is a view exemplifying behaviors of the controlled object;

FIG. 5 is a block diagram showing a configuration of a system for adjusting control parameters;

FIG. 6 is a flow chart showing processes of adjusting the control parameters;

FIG. 7 is a view exemplifying the content of the processes; and

FIG. 8 is a block diagram showing a configuration of a system to which the parameter setting device of the invention is applied when preparing a model.

### PREFERRED EMBODIMENT OF THE INVENTION

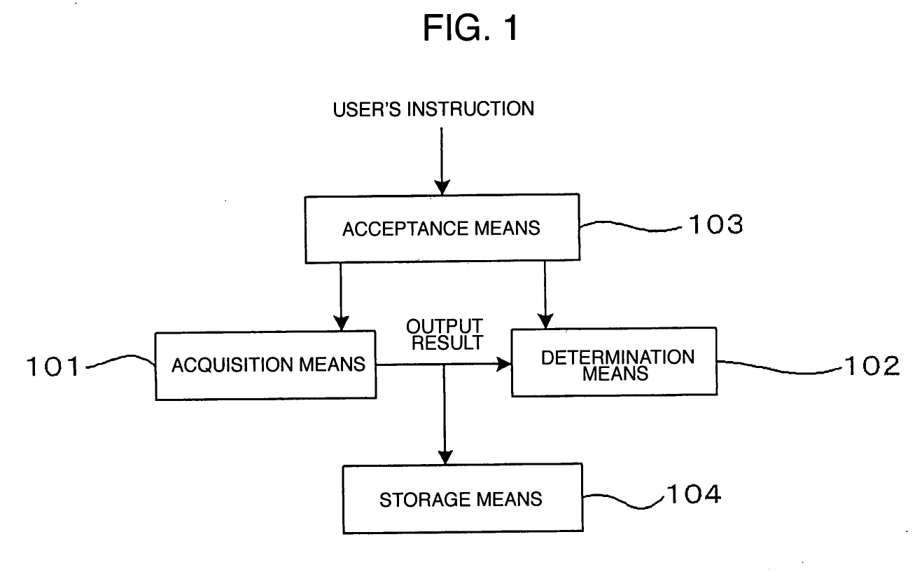

FIG. 1 is a block diagram functionally showing a parameter setting device of the invention.

In FIG. 1, an acquisition means 101 is used in a system where output results undergo variation according to parameters, and acquires the output results while varying parameter values of the parameters. A determination means 102 determines optimum parameter values on the basis of the output results acquired by the acquisition means 101. An acceptance means 103 accepts a user's instruction for determining a procedure of acquiring the output results by the acquisition means 101, and a method of determining the optimum parameter values by the determination means 102. A storage means 104 stores the output results acquired by the acquisition means 101.

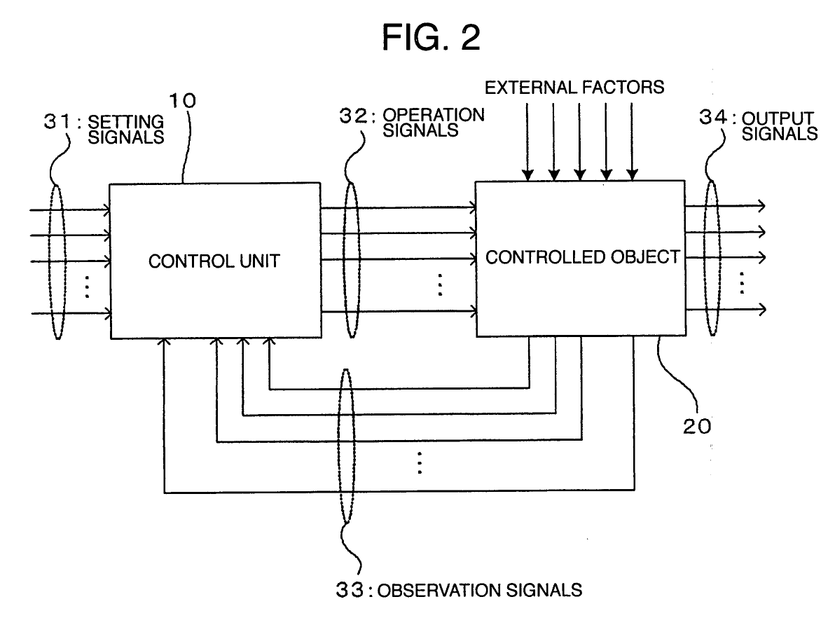

An embodiment of the parameter setting device of the invention is now described with reference to FIG. 2 to FIG. 8.

FIG. 2 is a block diagram showing a configuration of a control system for controlling a controlled object by use of a multitude of control parameters.

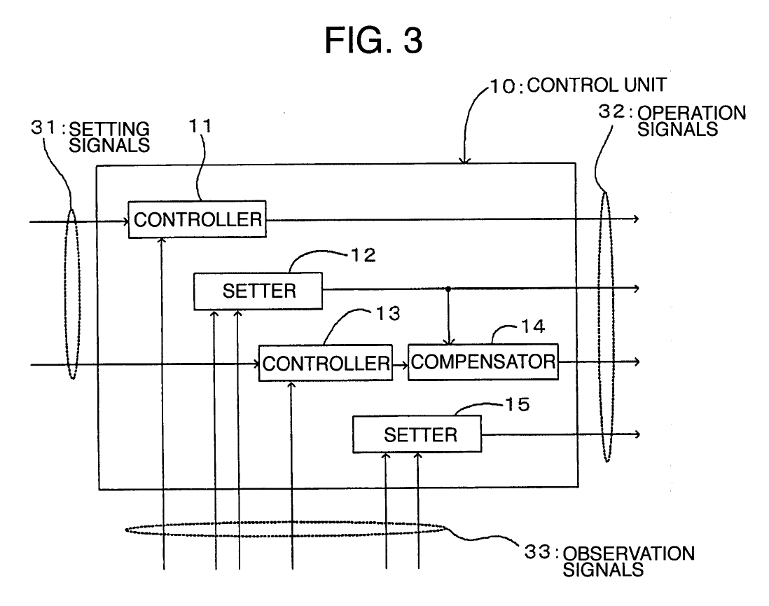

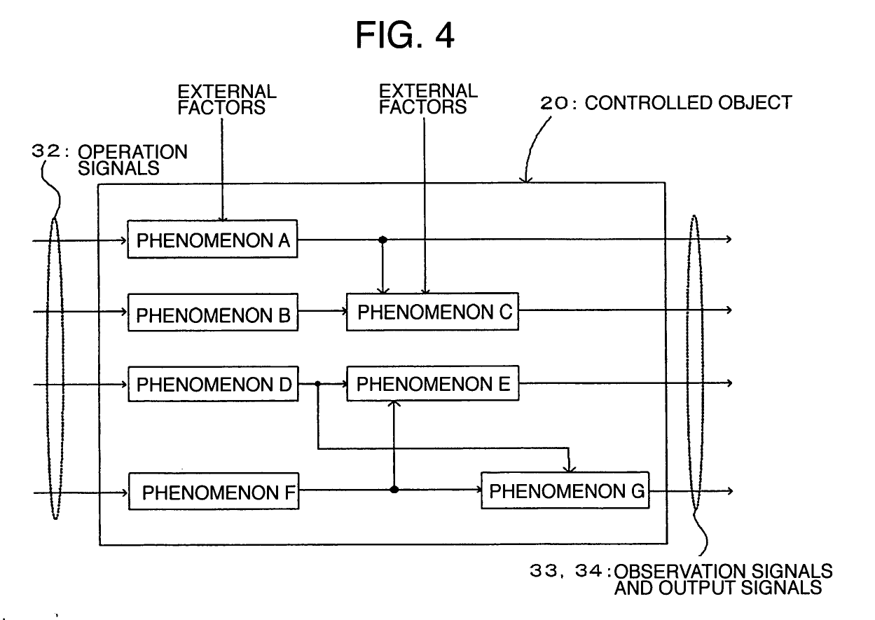

As shown in FIG. 2, the control system has a control unit 10 for controlling a controlled object 20. FIG. 3 is a block diagram exemplifying a configuration of the control unit 10, and FIG. 4 is a view exemplifying behaviors of the controlled object 20.

As shown in FIG. 2, setting signals 31 for defining contents of control are given to the control unit 10. Observation signals 33 which are returned from the controlled object 20 are also given to the control unit 10. As shown in FIG. 3, the control unit 10 has controllers 11, 13, setters 12, 15 and a compensator 14, wherein calculation is performed on the basis of the setting signals 31 and the observation signals 33. Results of calculation are outputted as operation signals 32 and given to the controlled object 20.

In FIG. 3, the operations of the controllers 11, 13, the setters 12, 15 and the compensator 14 are defined by a multitude of control parameters. It is possible to optimize the control with respect to the controlled object 20 by adjusting these control parameter values to be used by the control unit 10. An adjustment method of the control parameters is described later.

As shown in FIG. 2 and FIG. 4, the controlled object 20 accepts the operation signals 32 and external factors to generate chain of phenomena A to G, and the observation signals 33 and the output signals 34 are outputted as a consequence thereof. Meanwhile, although the observation signals 33 and the output signals 34 are illustrated as individual signal groups in the example shown in FIG. 2, both the observation signals 33 and the output signals 34 may overlap each other.

A procedure for adjusting the control parameters by the control unit 10 is described next.

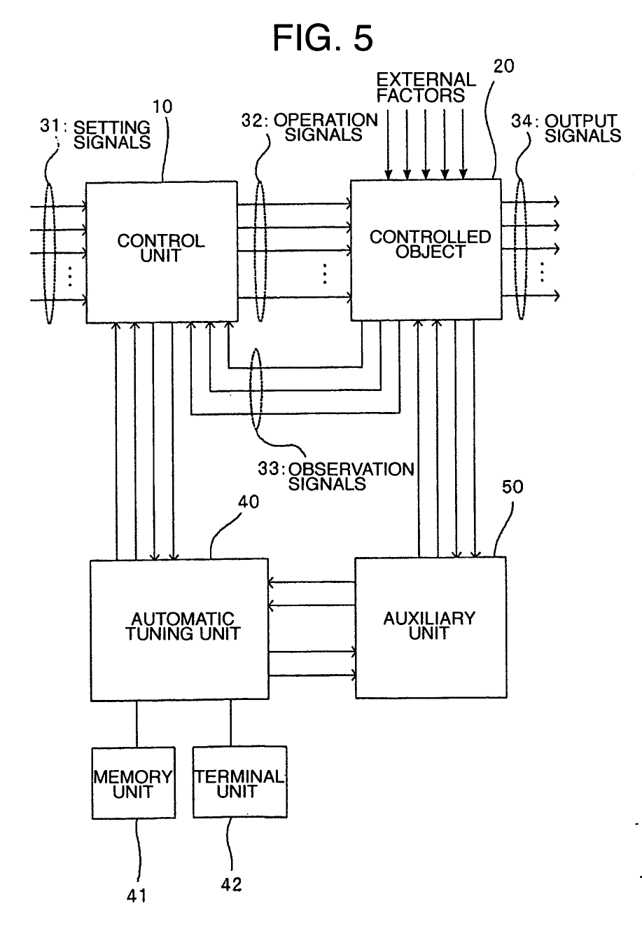

FIG. 5 is a block diagram showing a configuration of a system for adjusting control parameters by use of an automatic tuning unit 40. As shown in FIG. 5, the automatic tuning unit 40 is connected to the control unit 10. An auxiliary unit 50 serving as an interface with respect to the automatic tuning unit 40 is connected to the controlled object 20. Further, a memory unit 41 for storing data to be acquired at the time of adjustment of the respective control parameters and a terminal unit 42 for accepting a user's operation are connected to the automatic tuning unit 40.

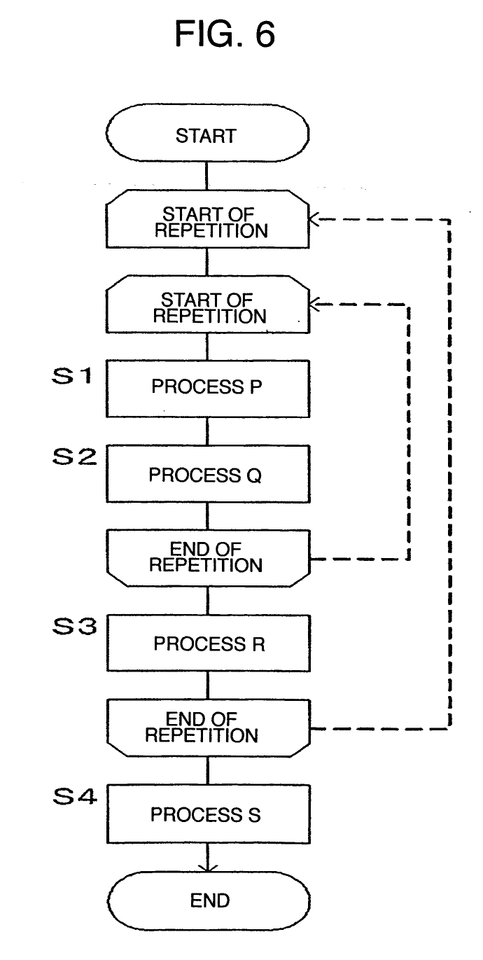

FIG. 6 is a flow chart showing processes of adjusting the control parameters. The processes are executed on the basis of a software which is packaged on the automatic tuning unit 40. This software accepts customization by a user while defining a skeleton of processes for optimizing the parameter values, thereby providing general versatility with respect to various parameter adjustments.

In the processes of repeating Step S1 to Step S3 in FIG. 6, output data are acquired while varying control parameter values. The output data are data which become determination materials when the control parameter values are optimized, and all data to be obtained from the control unit 10 and the controlled object 20 as well as the output signals 34 become objects of the output data. The output data obtained by a specific process may by used as input data for use in other processes.

In the processes, as shown in FIG. 6, after “process P” and “process Q” are repetitively executed in Step S1 to Step S2, “process R” is executed in step S3. In the processes of repeating “process P”, “process Q” and “process R” (Step S1 to Step S3), a steady state and a transient state are sequentially prepared by varying control parameter values in accordance with a given procedure, thereby acquiring the output data.

Then, in “process S” in step S4 in FIG. 6, optimum control parameter values are determined on the basis of the output data acquired by the processes for repeating step S1 to step S3. With the procedure set forth above, the control parameter values are optimized.

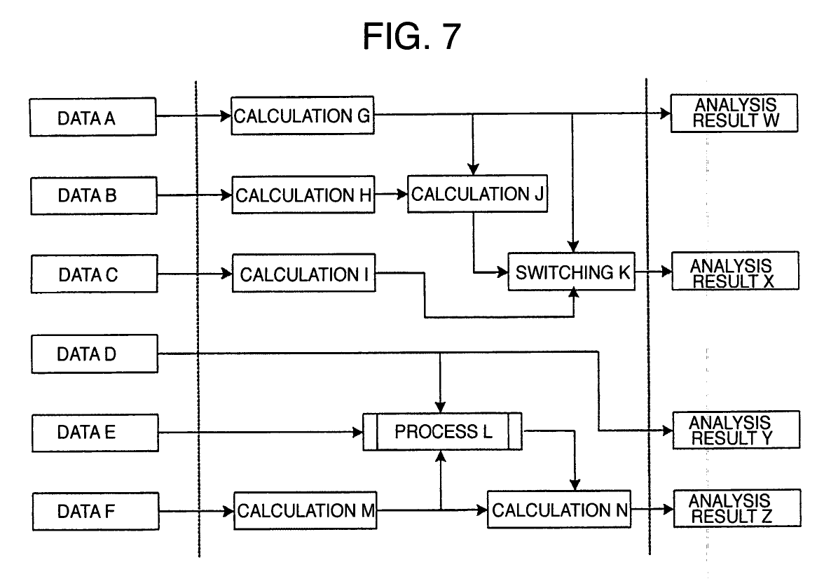

FIG. 7 is a view for exemplifying the contents of the processes of “process P” (Step S1), “process Q” (Step 2), “process R” (Step S3) or “process S” (Step S4).

According to the present embodiment, there are executed the processes as expressed in a functional block diagrammatic form as shown in FIG. 7. Herein, the processes using data A, data B, data C, data D, data E, and data F as respective input data are executed, thereby outputting an analysis result W, analysis result X, analysis result Y and analysis result Z as respective output data. These input data, and output data are sequentially stored in the memory (unit) 41 (FIG. 2) at the time of execution of the respective processes corresponding to those data.

With the present embodiment, since the data acquired at the time of adjustment of the respective control parameters are stored in the memory 41, not only temporary variables to be stored in the memory as the respective input data for use in the respective processes, but also the data stored in the memory 41 can be utilized, as needed. Various measurement data, halfway-through results, analysis results, and so forth, generated in the processes up to the preceding process, are put into a database to be stored in the memory 41, thereby rendering it possible to efficiently cope with manual correction of the halfway-through results, changes in a data processing method (e.g. calculation condition values), and so forth without repeating massive processes.

Further, with the present embodiment, it is possible to set the procedure for acquiring the output data, as shown in the flowchart of FIG. 6, on the basis of the user's instruction. For example, repetition in step S1 to step S3, or the repeat count, an end condition of repetition in the case of repetition of step S1 to Step S2, a procedure for determining how to vary control parameters at the time of repetition, and so forth can be set on the basis of the user's instruction. The content of the user's instruction is reflected on the processes shown in FIG. 6 through the above mentioned software.

Still further, with the present embodiment, algorism of the processes in “process P”, “process Q”, “process R” and “process S” can be set on the basis of the user's instruction. The automatic tuning unit 40 accepts the input of the functional block diagrammatic form shown in FIG. 7 via the terminal unit 42, and the block diagrammatic form is reflected on the processes shown in FIG. 6 through the above mentioned software. A method of inputting the block diagrammatic form may be created by preparing components such as “calculation G”, “switching K”, “process L” and so forth, and combining these components by a user.

In such a manner, according to the present embodiment, among the descriptive contents of the software program, there is to be accepted customization by the user with respect to a procedure for acquiring the output data and the algorism of the processes of “process P”, “process Q”, “process R” and “process S” while fixing the skeleton of the processes for optimizing the control parameters. Accordingly, it is not necessary for the user side to prepare the program by use of a program language from the beginning so that work for optimizing parameters can be efficiently implemented while avoiding enormous work to be required by the preparation of the program.

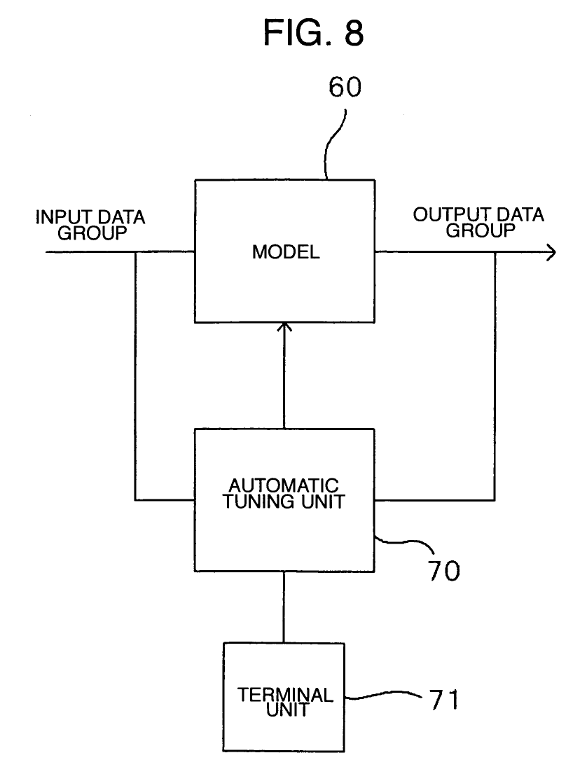

Further, although the example for adjusting the control parameters of the control unit is exemplified according to the present embodiment, as shown in FIG. 8, the parameter setting device of the invention can be applied to a system in the case of preparation of a model to be used in a simulation and so forth.

In the example shown in FIG. 8, an automatic tuning unit 70 for sequentially giving model parameters is connected to a model 60 having a multitude of model parameters. An input data group is given to the model 60 while the model parameters are varied. The automatic tuning unit 70 takes in an output data group outputted from the model 60 and calculates model parameter values so as to obtain appropriate output data values serving as a model. For example, in the case of a simulation model, model parameters are selected so as to become the same output data as a simulation object.

The procedure and algorism for optimizing parameter may use be the same as those used in the automatic tuning unit 40 (FIG. 5). Further, a user's instruction for determining the procedure and algorism by the user is accepted via the terminal unit 71.

A mode of the model 60 is not limited. For example, various mathematic models are applied as the model 60. Further, the model includes, for example, a differential equation, and so forth, and those for performing calculation on the basis of time series data, or a relational expression for causing the change in certain signals (input data) to invite change in different signals (output data) and so forth.

The parameter setting device is adaptable to various fields. For example, if the parameter setting device of the invention is adapted to the adjustment of the respective control parameters for controlling an automobile engine, optimum values of the control parameters can be found out when a user customizes the software without requiring automatic fitting work for a long period of time. Further, for example, in the case of optimizing fabrication processes of semiconductor devices, the optimum values of the parameters corresponding to individual fabrication processes can be easily obtained. Still further, in the case of determination of a medical policy, an architectural design, a machine tool design, or formulation of various policies and planning, values of several variables can be easily optimized by the customization of a software by the user.

As mentioned above, the parameter setting device of the invention can be applied to various fields handling a multitude of parameters, thereby enhancing a development efficiency, a production efficiency, a policy formulation efficiency and so forth.

The range of applications of the invention is not limited to the embodiment. The invention can be widely applied in the case of adjustment of parameters in a system where output results undergo variation according to the parameters.

What is claimed is:

1. A parameter setting device, for use in a system where output results undergo variation according to parameters, comprising:
an acquisition means for acquiring the output results while varying parameter values of the parameters; and
a determination means for determining optimum parameter values on the basis of the output results acquired by the acquisition means;
wherein the parameter setting device further comprises an acceptance means for accepting a user's instruction for determining a procedure of acquiring the output results by the acquisition means and a method of determining the optimum parameter values by the determination means.

2. A parameter setting device according to claim 1, wherein the acceptance means accepts an input of a functional block diagrammatic form by the user, and the method of determination is defined by the functional block diagrammatic form.

3. A parameter setting device according to claim 1, further comprising a storage means for storing the output results acquired by the acquisition means, and the determination means uses the output results stored in the storage means.

4. A parameter setting device according to claim 1, wherein the system is a controlled object where the parameters are control parameters.

5. A parameter setting device according to claim 1, wherein the system is a model where the parameters are model parameters.

6. A parameter setting method, for use in a system where output results undergo variation according to parameters, comprising:
a step of acquiring the output results by an acquisition means while varying parameter values of the parameters; and
a step of determining optimum parameter values on the basis of the output results acquired by the acquisition means;
wherein the parameter setting method further comprises a step of accepting a user's instruction for determining a procedure of acquiring the output results in the step of acquiring output results, and a method of determining the optimum parameter values in the step of determining optimum parameter values.

7. A parameter setting method according to claim 6, wherein an input of a functional block diagrammatic form by the user is accepted in the step of accepting the user's instruction, and the method of determination is defined by the functional block diagrammatic form.

8. A parameter setting method according to claim 6, further comprising a step of storing the output results acquired in the step of acquisition, and the stored output results are used in the step of determination.

9. A parameter setting method according to claim 6, wherein the system is a controlled object where the parameters are control parameters.

10. A parameter setting method according to claim 6, wherein the system is a model where the parameters are model parameters.

11. A program, for use in a system where output results undergo variation according to parameters, comprising:
a step of causing a computer to execute acquisition of the output results while varying parameter values of the parameters; and
a step of causing the computer to execute determination on optimum parameter values on the basis of the output results acquired by the acquisition means;
wherein the computer is caused to execute a step of accepting a user's instruction for determining a procedure of acquiring the output results in the step of causing the computer to execute the acquisition, and a method of determining the optimum parameter values in the step of causing the computer to execute the determination.

12. A program according to claim 11, wherein an input of a functional block diagrammatic form by the user is accepted in the step of accepting the user's instruction, and the method of determination is defined by the functional block diagrammatic form.

13. A program according to claim 11, further allowing the computer to execute a step of storing the output results acquired in the step of acquisition, and the stored output results are used in the step of determination.

14. A program according to claim 11, wherein the system is a controlled object where the parameters are control parameters.

15. A program according to claim 11, wherein the system is a model where the parameters are model parameters.
